(19) United States
(12) Patent Application Publication
(10) Pub. No.: US 2010/0201876 A1
(43) Pub. Date: Aug. 12, 2010

(54) Multimedia management device, system, and method

(76) Inventors: Yung-Chih Lin, Hsichih (TW); Po-Hsu Chen, Hsichih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/654,129

(22) Filed: Dec. 11, 2009

(30) Foreign Application Priority Data
Feb. 6, 2009 (TW) 98103976

(51) Int. Cl. H04N 3/27; G06F 3/048

(52) U.S. Cl. 348/554; 715/748; 715/810; 348/E03.049

(57) ABSTRACT

A multimedia management method is disclosed and applicable to a display device cooperating with at least a multimedia management device. The method preferably includes a first step of selecting one of the multimedia management devices from the display device. Next, the method is to browse the digital media servers which are listed by the multimedia management device. Further, the method is to select the multimedia files in one of the digital media servers. Lastly, the invention sends the selected multimedia file to the display device for displaying.

### BACKGROUND OF THE INVENTION

1. Field of the Invention

The present invention is related to a management device, system, and method, especially to a multimedia management device, system and method thereof.

2. Description of the Related Art

With the coming of consumer electronic age, electronic appliances are not limited to receive merely the wireless or cable channel programs, nor to display the video stored in a storage media such as a compact disc or a video tape. For example, a television is able to connect with a server through a network, and display a digital video file directly on the television.

Generally, there are many electronic appliances disposed at home, such as a mobile phone, a speaker, or a notebook computer, etc. If the users need to immediately acquire the stored digital contents, they may encounter a space limitation. For instance, if a user temporarily wants to use the multimedia files stored in the notebook computer, which locates in his study room, while he is watching movies through the television in the living room, he should go to the study room and use the notebook computer. For the user, there exists an inconvenience to be improved. If the conventional inconvenience needs to be improved, the limitations in time and space must be overcome. Thus the use mode of “enjoying the use of electronic appliances on the go” must be established.

With the digital electronic appliances have been widespread, the electronic appliances must be capable of directly displaying the digital video file. Therefore, a standard needs to be developed among the electronic appliances for operable with each other and sharing data.

The Digital Living Network Alliance (DLNA) sets up a unified transmission standard, in order to provide communication capabilities between the electronic appliances of different brands and types. Once in conformity with the standard of DLNA, the electronic appliances can directly connect to each other, work synchronously, and exchange data without a driving program. Generally speaking, if the television supports DLNA standard, it can browse and control all of the DLNA devices in the whole system through the built-in user interface screen. However, the television which supports the DLNA standard is still not commonly visible these days.

Therefore, for file sharing's convenience, the conventional home media management system must have a digital media adapter for providing a interface in order to provide users to view the digital media contents. Please refer to FIG. 1, which is a system structure chart of an embodiment of the original multimedia management system. As shown in FIG. 1, the multimedia management system 1 includes a display device 11, a multimedia management device 13, and a digital media server 15, wherein the three communicate with each other through a local area network. Specifically, the multimedia management device 13 is a digital media adapter (DMA), the display device 11 is a television, and the digital media server 15 can be the combination or one of the devices which includes a notebook computer, a speaker, a printer, a portable device, or a digital photographic device, in which the digital media server 15 stores multimedia files.

The display device 11 can browse or control the digital media server 15 under the whole DLNA environment through the multimedia management device 13, as well as viewing the stored multimedia contents: Generally, the display device 11 and the multimedia management device 13 have a remote control respectively. So if the user wants to view the multimedia contents, he needs to use the remote control of the display device 11 to turn on the display device 11, and then use the remote control of the multimedia management device 13 to browse, control, and view the multimedia contents. Further, if the other devices such as DVD player or speaker, etc. join, the necessary remote controls are too many in multimedia management system 1 to be managed.

### SUMMARY OF THE INVENTION

In light of the aforementioned defects, the present invention discloses a multimedia management device which includes CEC instructions. In which the CEC instructions are provided for users capable of directly controlling the display device to browse, view, and select the digital media contents in the networks in order to improve the use of digital home.

The present invention discloses a multimedia management device which is incorporated to at least a display device. The multimedia management device connects with at least a digital media server through a network. In which, the multimedia management device includes a first signal transceiver unit, a first processing unit, and a transmission unit. The first signal transceiver unit is used for sending and receiving at least an operation command or at least a multimedia file with the display device. The first processing unit is coupled with the first signal transceiver unit, in which the first processing unit includes a file management procedure for browsing or selecting the multimedia files in the digital media servers according to the operation command. The transmission unit is coupled with the first processing unit, for transmitting the multimedia files in the selected digital media server to the first processing unit. Additionally, the first processing unit controls the first signal transceiver unit for converting the multimedia files to displayable format, and sends the multimedia files to the display device.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a system structure chart of the original multimedia management device;

FIG. 2 is a system structure chart of an embodiment of multimedia management system according to the present invention;

FIG. 3 is a flow chart of an embodiment of multimedia management method according to the present invention;

FIG. 4A is a diagram of an embodiment of operation menu according to the present invention;

FIG. 4B is a diagram of an embodiment of menu file according to the present invention;

FIG. 4C is a diagram of another embodiment of menu file according to the present invention; and

FIG. 4D is a diagram of an embodiment of multimedia file screen according to the present invention.

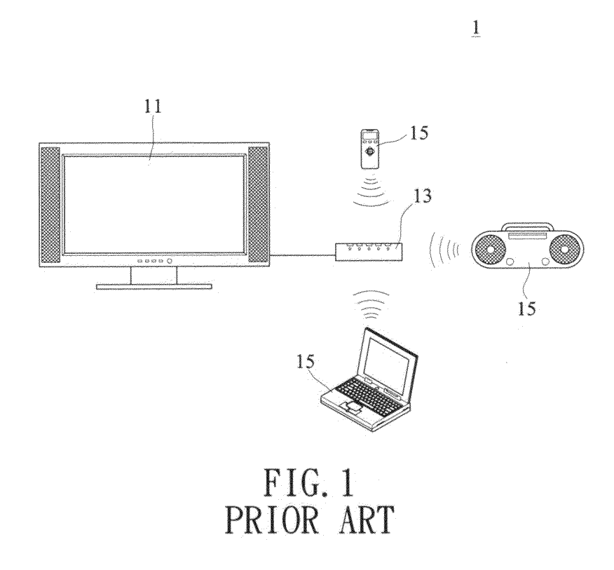

### DETAILED DESCRIPTION OF THE PREFERRED EMBODIMENTS

In light of the aforementioned defects, the present invention discloses a multimedia management device which includes CEC instructions. In which the CEC instructions are provided for users capable of directly controlling the display device to browse, view, and select the digital media contents in the networks, in order to improve the implementation of digital home.

The technical features of the present invention includes adding new control instructions in a multimedia management device, for achieving the purposes of browsing and selecting the digital media contents. The followings disclose the system structure and the process of method. However, besides the following mentioned components, a skilled person in the art can realize that there are still other necessary elements and functions included in. Thus the present invention is not limited by the following embodiments.

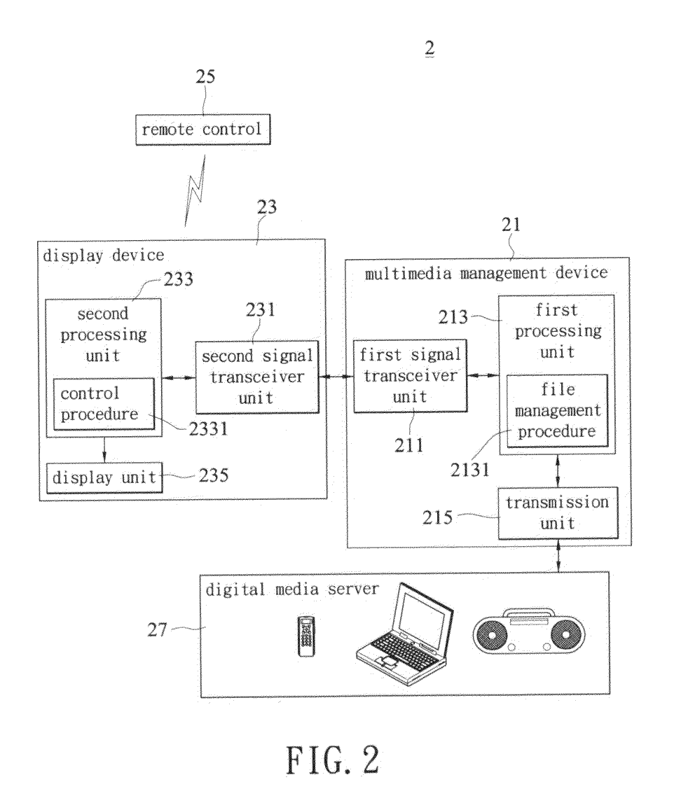

First, please refer to FIG. 2, which is a schematic diagram of the system of an embodiment of a multimedia management system. As shown in FIG. 2, the multimedia management system 2 includes a display device 23, a multimedia management device 21 and digital media servers 27. The signal and data transmissions of the multimedia management device 21 and the digital media servers 27 conform to the standard established by the Digital Living Network Alliance (DLNA). And the multimedia management device 21 and the display device 23 communicate to each other through the High Definition multimedia Interface (HDMI).

Specifically, the multimedia management device 21 is a digital media adapter (DMA). The display device 23 is preferably a television. The digital media server (DMS) 27 stores at least a multimedia file, and can be the combination or one of the notebook computer, a speaker, a printer, a mobile device, and a digital photographic device.

The multimedia management device 21 connects with the display device 23 and the digital media servers 27 through a local area network (LAN). In which, the multimedia management device 21 includes a first signal transceiver unit 211, a first processing unit 213, and a transmission unit 215. And the display device 23 includes a second signal transceiver unit 231, a second processing unit 233, and a display unit 235. The second signal transceiver unit 231 is used for receiving an operation command which is inputted by a user using a remote control 25 or a touch control.

In which, the operation command is an infrared control signal or a signal which conforms the communication protocol of Consumer Electronic Control (CEC), for respectively controlling the display device 23 and the multimedia management device 21 which connects to the display device 23 through HDMI. Common CEC signals such as one-touch play, one-touch record, system information, and system standby, etc. The signals are provided for the users to control the HDMI device with high logicality and convenience.

Further, the second processing unit 233 is coupled between the second signal transceiver unit 231 and the display unit 235, in which the second processing unit 233 is used for executing relative processes according to the operation command, such as choosing channels, adjusting volume, and turning on or off. Besides the ordinary functions, the second processing unit 233 further has a control procedure 2331 which is controlled by the operation command, and used for the user selecting and browsing the contents of the multimedia management device 21. If the user inputs the operation command (CEC signal) for controlling the multimedia management device 21, and the second processing unit 233 then controls the second signal transceiver unit 231 for sending the operation command to the multimedia management device 21.

Additionally, the first signal transceiver unit 211 corresponds to the second signal transceiver unit 231, and the first signal transceiver unit 211 is used for receiving and sending the operation command. The first processing unit 213 couples with the first signal transceiver unit 211, in which the first processing unit. 213 is used for executing relative processes according to the operation command. Specifically, the first processing unit 213 has a file management procedure 2131, which is controlled by the operation command for executing functions such as system standby, menu control, and multimedia fast forward, etc, or for letting users browse or select the data, like text files or multimedia files, in the digital media server 27.

Moreover, the transmission unit 215 couples with the first processing unit 213. In which, the transmission unit 215 can be a device using wireless or cable communication techniques, for transmitting multimedia files from the selected digital media server 27 to the first processing unit 213. Thus the first processing unit 213 is capable of controlling the first signal transceiver unit 211 for transmitting multimedia files and relative operation commands to the second signal transceiver unit 231. After the multimedia files are decompressed or converted to a certain format by the first processing unit 213, the multimedia files are sent to the display unit 235 for displaying.

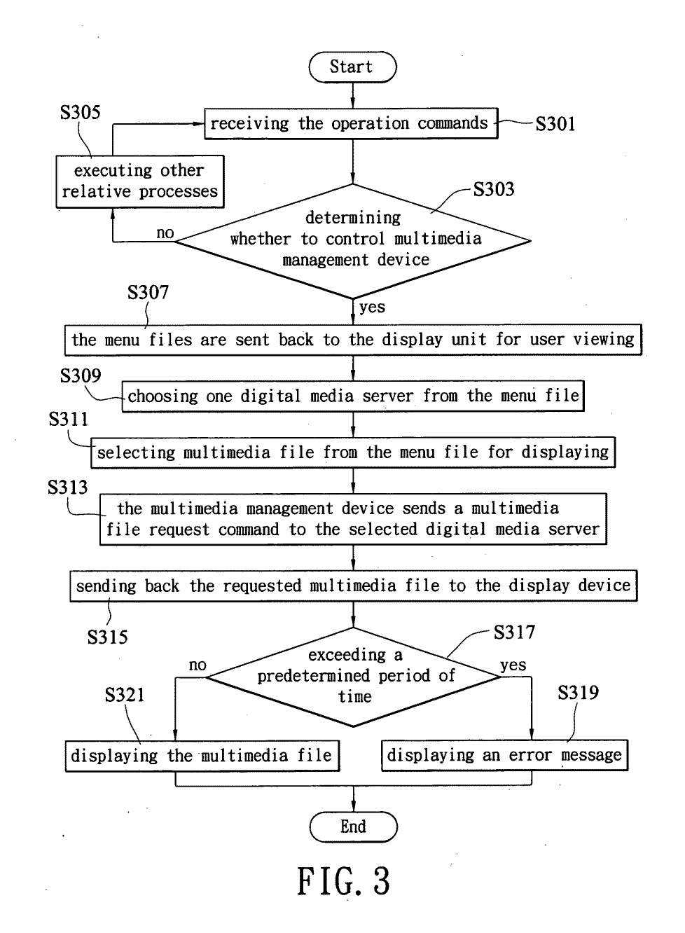

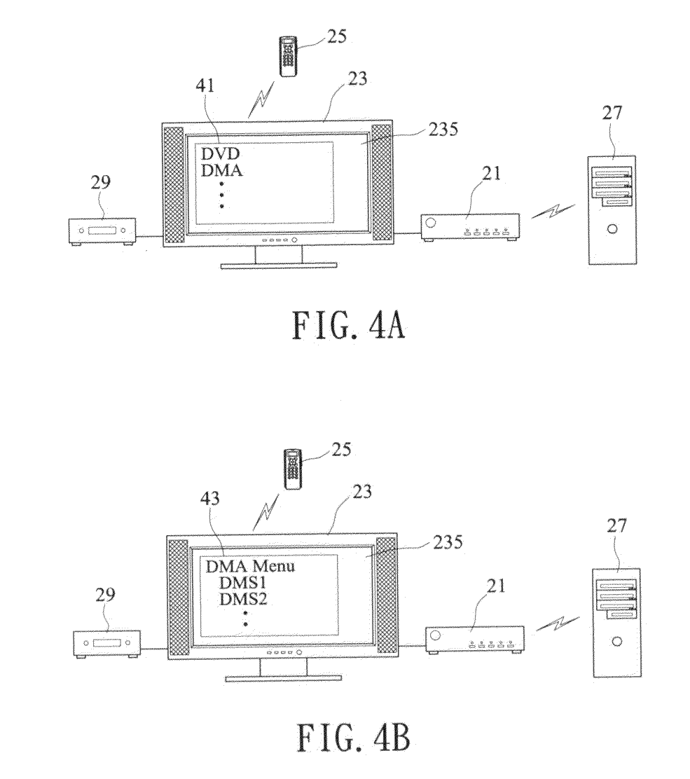

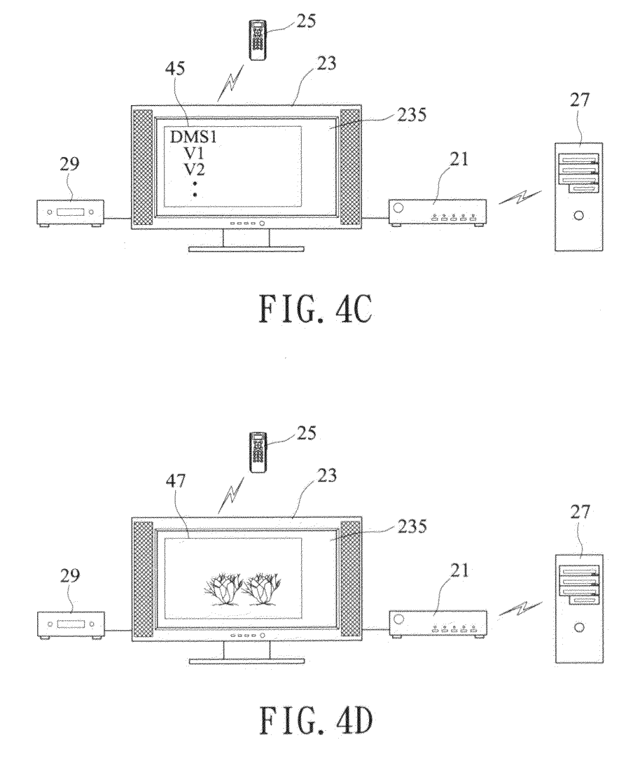

Please refer to FIG. 3 for further understanding the operation of the disclosed multimedia management system 2, in which FIG. 3 is a flow chart of an embodiment of a multimedia management method. In correspondence with the system structure shown in FIG. 2 and the operating interface shown in FIGS. 4A, 4B, 4C, and 4D, the FIG. 3 describes the multimedia management method as follows:

First, the second signal transceiver unit 231 receives the operation command generated from the remote control 25 (S301). Specifically, the display device 23 can be coupled with at least a peripheral device 29 in addition to the multimedia management device 21, for controlling the peripheral device 29 by inputting the operation commands to the peripheral device 29. Wherein the peripheral device 29 can be one or the combination of the DVD recorder and set-up box (STB).

The second processing unit 233 executes the control procedure 2331, for displaying the operation menu 41 which lists the devices currently connecting with the display device 23, as shown in FIG. 4A, and receiving user's selection and browse among the listed devices. If the user selects one of the devices from the operation menu 41 as a signal source, then the second processing unit 233 determines whether to control a multimedia management device 21 (S303). Wherein the multimedia management system 2 may include several multimedia management devices 21, so the user can choose one of the multimedia devices 21 which supports CEC standard.

If the determination result of S303 is negative, then the step goes to execute other relative processes (S305). Otherwise, if the determination result of S303 is positive, then the screen of the display device 23 switches to the operation interface of the selected multimedia management device 21 for further controlling the multimedia management device 21. The multimedia management device 21 then collects the information of all the connected digital media servers 27 and the information of the multimedia files in the digital media server 27, by executing the file management procedure 2131. The information sets of all the digital media servers 27 are combined into a menu file 43, and the information sets of the multimedia files are combined into menu files 45. Further, the menu file 43 and 45 are sent back to the display unit 235 for user viewing (S307).

Next, the user chooses one digital media server 27 from the menu file 43 (S309), then he or she may view the menu file 45 of the digital media server 27, as shown in FIG. 4C, and select multimedia file from the menu file 45 for displaying (S311). Afterward, the multimedia management device 21 sends a multimedia file request command to the selected digital media server 27 through local area network (S313). Then the digital media server 27 sends back the multimedia file to the multimedia management device 21. The multimedia file is converted to a displayable format by the first processing unit 213, and the multimedia file is received by the second signal transceiver unit 231 of the display device 23 (S315).

Lastly, the second processing unit 233 may determine whether the responding time of the multimedia file exceeds a predetermined period of time (S317). If the determination result is true, it may indicate that the requested multimedia files are not exist or the transmission fails, and then the display unit 235 displays an error message to inform the user of the condition (S319). Otherwise, if the second processing unit 233 receives the requested multimedia file in the predetermined period of time, the display unit 235 then displays the processed multimedia file screen 47 (S321), as shown in FIG. 4D.

By the description mentioned above, it is noted that the multimedia management device, system, and the method of the present invention provide an extra file management procedure to the basic CEC instruments, so the users can input commands directly to the display device for controlling the multimedia management device to display the information of all the digital media servers and the multimedia files. And the environment for user to browse, view, and select any of the multimedia files improves due to the tree structure of display mode.

The description above only illustrates specific embodiments and examples of the invention. The invention should cover various modifications and variations made to the structures and operations described herein, and they still fall within the scope of the invention as defined in the following appended claims.

What is claimed is:

1. A multimedia management device, which cooperates with at least one display device, in which the multimedia management device connects to at least one digital media server through a network, the multimedia management device comprising: a first signal transceiver unit, for sending and receiving at least an operation command and at least a multimedia file regarding the display device; a first processing unit, coupled with the first signal transceiver unit, in which the first processing unit includes a file management procedure for browsing or selecting the multimedia file in the digital media server according to the operation command; and a transmission unit, coupled with the first processing unit, for transmitting the multimedia file in the digital media server selected by the first processing unit; wherein the first processing unit controls the first signal transceiver unit for converting the multimedia file to a displayable format, and sending the multimedia file to the display device.

2. The multimedia management device as in claim 1, wherein the display device comprises: a second signal transceiver unit, for sending and receiving the operation command and the multimedia file regarding the multimedia management device; a second processing unit, coupled with the second signal transceiver unit, in, which the second processing unit includes a control procedure for browsing and selecting the contents of the multimedia management device according to the operation command; and a display unit, coupled with the second processing unit, for displaying the multimedia file which has been processed.

3. The multimedia management device as in claim 1, wherein the operation command is inputted from a remote control to the display device.

4. The multimedia management device as in claim 1, wherein signal transmissions of the multimedia management device and the digital media server are in conformity with the standard established by Digital Living Network Alliance.

5. The multimedia management device as in claim 1, the multimedia management device is a digital media adapter.

6. The multimedia management device as in claim 1, wherein the operation command conforms to the communication protocol of Consumer Electronic Control.

7. A multimedia management system, comprising: a display device, for sending or receiving at least one operation command; at least one digital media server, which saves at least one multimedia file; a multimedia management device, coupled between the display device and the digital media server, including: a first signal transceiver unit, for receiving the operation command; a first processing unit, coupled with the first signal transceiver unit, in which the first processing unit includes a file management procedure for browsing or selecting the multimedia file in the digital media server according to the operation command; and a transmission unit, coupled with the first processing unit, for transmitting the multimedia file in the digital media server selected to the first processing unit; wherein the first processing unit controls the first signal transceiver unit for converting the multimedia file to a displayable format, and sending the multimedia file to the display device.

8. The multimedia management system as in claim 7, wherein the display device comprises: a second signal transceiver unit, for receiving the operation command, and sending the operation command to the multimedia management device; a second processing unit, coupled with the second signal transceiver unit, in which the second processing unit includes a control procedure for browsing and selecting the contents of the multimedia management device according to the operation command; and a display unit, coupled with the second processing unit, for displaying the multimedia file which has been processed.

9. The multimedia management system as in claim 7, wherein signal transmissions of the multimedia management device and the digital media server are in conformity with the standard established by Digital Living Network Alliance.

10. The multimedia management system as in claim 7, wherein the multimedia management device is a digital media adapter.

11. The multimedia management system as in claim 7, wherein the operation command conforms to the communication protocol of Consumer Electronic Control.

12. The multimedia management system as in claim 8, wherein the operation command is inputted from a remote control to the second signal transceiver unit.

13. The multimedia management system as in claim 8, wherein the first signal transceiver unit and the second signal transceiver unit transmit the multimedia file through a High Definition Multimedia Interface.

14. A multimedia management method, applicable to a display device cooperating to at least one multimedia management device, wherein each of the multimedia management devices includes a menu file which records information of at least one digital media server, the method comprising: selecting one of the multimedia management devices from the display device; viewing the menu file of the selected multimedia management device; selecting a multimedia file in one of the digital media servers from the menu file; and sending the multimedia file to the display device.

15. The multimedia management method as in claim 14, wherein before the step of selecting the multimedia management device further comprises: roviding a file management procedure in the multimedia management device; inputting an operation command to the display device; and determining whether or not to execute the file management procedure according to the operation command.

16. The multimedia management method as in claim 15, wherein the steps of viewing the menu file and selecting the multimedia file are carried out by executing the file management procedure.

17. The multimedia management method as in claim 14, wherein the step of sending the multimedia file to the display device further comprises: determining whether or not the display device receives the multimedia file in a predetermined period of time; if the determination result is positive, then the display device displays the multimedia file; and if the determination result is negative, then the display device displays an error message.

18. The multimedia management method as in claim 14, wherein signal transmissions of the multimedia management device and the digital media server are in conformity with the standard established by Digital Living Network Alliance.

19. The multimedia management method as in claim 15, wherein the operation command is inputted from a remote control to the display device.

20. The multimedia management method as in claim 15, wherein the operation command conforms to the communication protocol of Consumer Electronic Control.
